(19) United States
(12) Patent Application Publication
(10) Pub. No.: US 2018/0177191 A1
(43) Pub. Date: Jun. 28, 2018

(54) PROCESS FOR REDUCING THE CORROSIVENESS OF A BIOCIDAL COMPOSITION CONTAINING IN SITU GENERATED SODIUM HYPOCHLORITE

(71) Applicant: Buckman Laboratories, Memphis, TN (US)

(72) Inventor: Michael Luke Corcoran, Memphis, TN (US)

(21) Appl. No.: 15/833,606

(22) Filed: Dec. 6, 2017

Related U.S. Application Data
(60) Provisional application No. 62/439,229, filed on Dec. 27, 2016.

(51) Int. Cl. A01N 59/00; C01C 1/16; C25B 1/24

(52) U.S. Cl. CPC A01N 59/00; C01C 1/164; C01B 11/062; C25B 1/24; C01C 1/166

(57) ABSTRACT

A process for substantially reducing the corrosiveness of a composition containing in situ generated sodium hypochlorite in which the sodium hypochlorite is substantially converted to a haloamine.

### CROSS-REFERENCE TO RELATED APPLICATIONS

This application claims the benefit of U.S. Provisional Application No. 62/439,229, filed on 27 Dec. 2016, which is hereby incorporated by reference in its entirety.

### TECHNICAL FIELD

This invention relates to a process for reducing the corrosiveness of a biocidal composition containing sodium hypochlorite. In a more specific aspect, this invention relates to a process for reducing the corrosiveness of a biocidal composition containing sodium hypochlorite generated in situ in a electrolytic cell.

There is an ongoing need for improved methods and system for controlling undesired microorganisms in many industries and a need exists for more environmentally friendly methods of controlling microorganisms which have a greater persistence and greater ability to control these microorganisms. Typical methods involve the employment of chlorine in the form of chlorine gas or hypochlorous acid made from bleach. However, while these chemicals react quickly against the organisms of interest, they also react with other organic or carbon containing material in the water often generating undesirable chlorocarbon byproducts such as chloroform and carbon tetrachloride, both of which are very undesirable insomuch that they are hazardous and dangerous chemicals.

With the decline in the use of gaseous chlorine as a microbicide and bleaching agent due to concerns related to safety and security, various alternative biocides have been explored, including bleach, bleach with bromide, bromochlorodimethyl hydration, chlorinated and brominated triazines, ozone, chlorine dioxide (ClO₂) and monochloramine (NH₂Cl).

Of these alternative biocides, monochloramine (MCA) has generated a great deal of interest for control of microbiological growth in a number of industries, including the dairy industry, the food and beverage industry, the pulp and paper industries, the fruit and vegetable processing industries, various canning plants, the poultry industry, the beef processing industry, and miscellaneous other food processing applications.

The use of monochloramine is rising in potable water applications, such as municipal potable water treatment facilities; potable water pathogen control in office building and healthcare facilities; industrial cooling loops; and in industrial waste treatment facilities, because of its selectivity towards specific environmentally-objectionable waste materials. Prior methods for the control of microorganisms in these potable water applications typically involved the employment of bleach or chlorine gas resulting in the formation of hypochlorous acid (HOCl) which then reacts with other carbon containing substances in the water lines and forms the aforementioned chlorocarbons rendering the HOCl essentially useless and unable to control the microorganisms of interest.

Therefore, as a result of the above benefits, chloramines are currently being utilized as disinfectants in public water supplies and bromoamines are currently being used as disinfectants in the medical community and for the disinfection of swimming pool and cooling tower waters. Chloramine is commonly used in low concentrations as a secondary disinfectant in municipal water distribution systems (and is normally generated at the municipal water treatment site using anhydrous ammonia) as an alternative to chlorination.

Chlorine is, therefore, being displaced by chloramine-primarily monochloramine (NH₂Cl or MCA) which is more stable and does not dissipate as rapidly as free chlorine and has a lower tendency than free chlorine to convert organic materials into chlorocarbons, such as chloroform and carbon tetrachloride.

Unlike chlorine dioxide or chlorine which can vaporize into the environment, monochloramine remains in solution when dissolved in aqueous solutions and does not ionize to form weak acids. This property is at least partly responsible for the biocidal effectiveness of monochloramine over a wide pH range.

Methods for the production of chloramines are well known in the art. For example, chloramine can be produced by one or more techniques described in U.S. Pat. Nos. 4,038,372; 4,789,539; 6,222,071; 7,045,659 and 7,070,751.

The microbicidal activity of monochloramine is believed to be due to its ability to penetrate bacterial cell walls and react with essential enzymes within the cell cytoplasm to disrupt cell metabolism (specifically sulfhydryl groups —SH). This mechanism is more efficient than other oxidizers that “burn” on contact and is highly effective against a broad range of microorganisms. Monochloramine has demonstrated excellent performance against difficult to kill filamentous bacteria and slime-forming bacteria and has shown better penetration and removal of biofilm when compared to traditional biocides.

Furthermore, Monochloramine has demonstrated: excellent results for maintaining system cleanliness; better penetration and removal of biofilm; reduction of inorganic and organic deposits; reduced system cleaning frequency; improved cooling efficiency; better disinfecting properties than conventional oxidants; better performance in high-demand systems, it is not impacted by system pH; and is efficient against Legionella and Amoeba.

Additionally, MCA demonstrates very effective control of hydrogen sulfide by reacting with hydrogen sulfide itself to form nonhazardous byproducts.

Unfortunately, MCA can become unstable and hazardous under certain temperature and pressure conditions. Although this may only be an issue of concern for solutions of relatively high concentration(s), the shipment of MCA, at any concentration, is highly restricted. MCA and other haloamines have not been used in the petroleum industry due to a number of safety related issues, such as on site storage concerns of pressurized anhydrous ammonia and because shipment of MCA is difficult and furthermore, the MCA will degrade over time if manufactured at one site and shipped to another.

In the petroleum industry, numerous agents or contaminants can cause damage to or restriction of the production process. A number of microorganisms have been proven to cause a wide range of negative effects on oil and gas operations ranging from reduced formation flow (due to biofilm formation) to corrosion (as a result of acid formation such as H₂S) resulting in subsequent equipment failure. Many of the polymers utilized in oil and gas production operations can be metabolized by such microorganisms resulting in polymer performance degradation and higher growth rates for these microorganisms. Examples of such polymers are: polyacrylamides; carboxymethylcellulose (CMC); hydroxyethylcellulose (HEC); hydroxypropyl guar (HPG); acrylamidomethylpropanesulfonic acid and xanthan gum.

Some of the contaminants found in oil and gas applications, such as bacteria, may, occur naturally in a formation or be present from prior human interactions (for example, microbes introduced from makeup water or contaminated equipment employed in the recovery of oil and gas). For example, bacteria are often inadvertently introduced to a formation during operations, such as drilling and workover (e.g., the repair or stimulation of an existing production well). Similarly, during a fracturing process, bacteria are often inadvertently introduced into the wellbore and forced deep into the formation, such as a result of contaminated or improperly treated waters or contaminated proppants being injected into the formation. Additionally, during these processes and practices, the bacteria are often spread and with the subsequent distribution of these bacteria, that bacteria with new cellular and biochemical technologies may be made available to new locations and new nutrients which can accelerate their growth and proliferation. The slime-former organisms grow and develop and secrete sticky, slime exopolymers that adhere to surfaces. As inorganic materials adhere to the slime exopolymer, a hard mass will develop. These hard masses block important passages in the recovery of oil and gas.

Often polymers such as CMC, HPG, xanthan gum, acrylamidomethylpropanesulfonic acid and polyacrylamides are added to the fracturing fluid to maintain the proppant in suspension and to reduce the friction of the fluid. Bacteria entrained within this fluid penetrate deep into the formation, and once frack pressure is released, may become embedded within the strata (in the same manner as the proppant deployed), and these polymers then become nutrients for bacteria to grow and multiply.

Many bacteria that are found in oil and gas application are facultative anaerobes. That is, these bacteria can exist (metabolize) in either aerobic or anaerobic conditions using either oxygen (i.e., such as molecular oxygen or other oxygen sources (such as NO₃) or non-oxygen electron acceptors (sulfur) to support their metabolic processes. Under the right conditions, facultative anaerobes can use sulfate as an oxygen source and respire hydrogen sulfide, which is highly toxic to humans in addition to being highly corrosive to steel.

Additionally, in a process known as Microbiologically Induced Corrosion (MIC), bacteria will attach to a substrate, such as the wall of a pipe in the wellbore or in a formation which has undergone hydraulic fracturing, and form a “biofilm” shield around the substrate. Underneath, the bacteria metabolize the substrate (such as a mixture of hydrocarbon and metallic iron) and respire hydrogen sulfide, resulting in the metal becoming severely corroded in the wellbore, leading to pipe failure, damage to downhole equipment, costly repairs and downtime. The production of hydrogen sulfide as a byproduct also complicates the refining and transportation processes, and reduces the economic value of the produced hydrocarbon. Hydrogen sulfide is a poisonous and explosive gas and, therefore, a serious safety hazard. Thus, the presence of hydrogen sulfide makes operations unsafe to workers and can be costly to the operators in terms of down time and damage to expensive equipment.

Traditional methods, when used alone to address these problems, often have drawbacks. For example, a present industry practice is to add conventional organic and inorganic biocides, such as quaternary ammonium compounds, aldehydes (such as glutaraldehyde), tetrakishydroxymethylphosphoniumsulfate (THPS) and sodium hypochlorite, to fracturing fluids and possibly other additives to control bacteria. The efficacy of these conventional biocides alone, however, can be minimal due to the type of bacteria that are typically found in hydrocarbon-bearing formations and petroleum production environments. More particularly, only a small percentage of these bacteria which are native to the formation (which are often found in volcanic vents, geysers and ancient tombs) are active at any one time; the remainder of the population is present in a dormant or spore state.

The aforementioned conventional biocides often have no, or limited, effect on dormant and endospore forming bacteria. Thus, while the active bacteria are killed to some extent, the inactive bacteria survive and thrive once favorable environmental conditions are achieved within the formation. Additionally, these conventional biocides often become inactivated when exposed to many of the components found in petroleum production formations and, furthermore, microorganisms can build resistance to these conventional biocides, thus limiting the utility of the biocides over time.

Bacteria do not develop resistance to industrial biocides the same way bacteria develop resistance to antibiotics (i.e., conventional biocides). Industrial biocides will attack the metabolic process of a cell at many different steps, while antibiotics will attack a single enzyme at a specific metabolic step. Organisms that do not use that particular enzyme at that specific metabolic step are not affected by the antibiotic. However, industrial biocides will attack many different metabolic enzymes, which renders the organisms susceptible to the effect of the biocide.

Currently, numerous microbicides are available on the market for the oil and gas industry. But many of these microbicides are of concern due to potential long term detrimental effects such as introduction into aquifers. There exists a strong need for a “green biocide” which can accomplish the stated objectives but which (if inadvertently introduced into an aquifer or other water supply intended for human and/or animal consumption) will not result in nearly as serious debilitating effects.

Owing to a number of safety related issues such as on site storage concerns of pressurized anhydrous ammonia, until the present invention, the use of haloamines in the oil and gas industry has not been proposed, and employment of portable haloamine generators has not been applied in the upstream, midstream or downstream in the oil and gas industry. The present invention has overcome these issues.

There is a continuing need for improved biocides that can be used in the oil and gas industry. Among the biocides currently being utilized in the oil and gas industry, biocides such as glutaraldehyde; THPS; quaternary amines and acrolein are or have been used. The toxicity of these biocides can be of significant concern to oil and gas field operating personnel. For example, the biocide acrolein has a very high toxicity and can even dissolve the rubber soles and heels of worker's shoes and boots. Typically, such biocides are fed manually into a containment tank in “slug dosage” exposing the operating personnel to potentially serious risk.

There is also a continuing need for improvements in portable haloamine generation in terms of costs, design considerations and ease of use for industries presumably not utilizing this technology, such as the oil and gas industry. The present invention addresses these and other needs.

This invention will be described with specific reference to monochoramine as the haloamine. However, this invention will be understood as applicable to other haloamines, such as monobromoamine.

### SUMMARY OF THE INVENTION

Briefly described, the present invention is directed to a process for reducing the corrosiveness of a biocidal composition which contains sodium hypochorite, which is generated in situ in an electrolytic cell, such as by processing an electric current through an aqueous salt water composition.

The process of this invention results in a biocidal composition having a substantially reduced corrosiveness as compared to the corrosiveness of the composition containing the in situ generated sodium hypochlorite.

The substantially reduced corrosiveness is due primarily to the use of an ammonia-containing material which converts most, if not all, of the sodium hypochorite to a haloamine.

### BRIEF DESCRIPTION OF THE DRAWINGS

FIGS. 1 and 2 are Tables showing the biocidal properties of sodium hypochlorite and monochoramine.

FIG. 3 is a flow chart of the process described in Example 1.

FIG. 4 is a flow chart of the process described in Example 2.

### DETAILED DESCRIPTION OF THE INVENTION

The present invention provides a biocidal composition which can be effectively used in situations where undesired microorganisms are present, such as in the oil and gas industry. In that industry, metal equipment is frequently used which is subject to corrosion from microorganisms. Corrosion of this equipment often results in downtime in the industry for cleaning and/or replacement of the equipment or replacement of corroded parts.

Sodium hypochlorite is a compound having known biocidal properties. However, as explained above, the use of sodium hypochlorite can cause corrosion problems, especially with equipment which is primarily made of metal or having metallic parts, such as equipment used in the oil and gas industry.

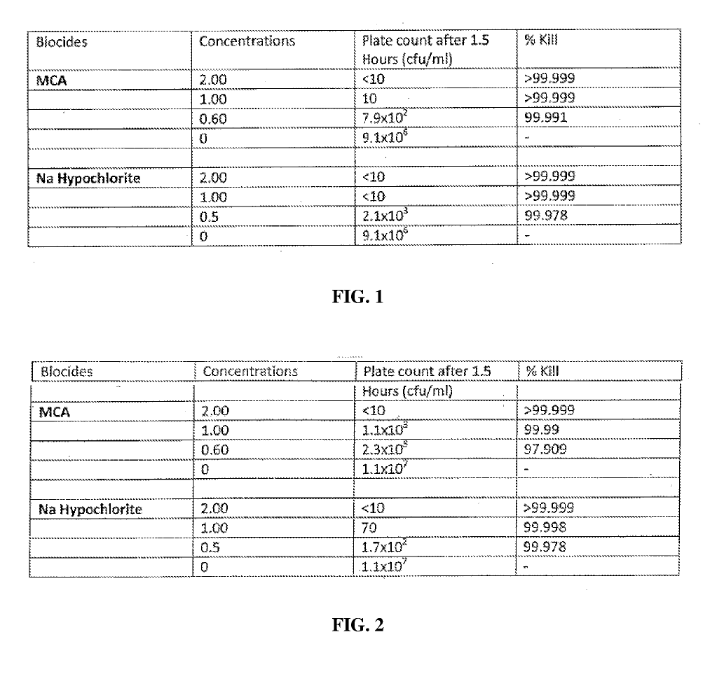

Halomines, such as monochloramine, are similarly known for their biocidal properties. The data shown in the Tables of FIGS. 1 and 2 demonstrate the biocidal properties of sodium hypochlorite and monochloramine.

The data from kill studies which is presented in FIGS. 1 and 2 was produced using the following procedures.

The kill studies were done in synthetic cooling water, pH 8.0, at room temperature. Suspensions of overnight cultures of Pseudomonas aeruginosa or Enterobacter aerogenes were added to the synthetic cooling water, followed by the biocide in the desired concentrations. The biocide concentrations were based on the active levels added to the test medium rather than the total residual chlorine. The contact time was 1.5 hours.

Monochloramine (MCA) can be prepared by a standard procedure in the lab at Buckman Laboratories (Memphis, Tenn.). Sodium hypochlorite (Na Hypochlorite) was a 5.0% solution obtained from Ricca Chemical Company (Arlington, Tex.).

Tables 1 and 2 show the biocidal properties of these 2 materials.

Although commonly used in oil and gas waterfloods for biocidal properties, sodium hypochlorite can lead to problems with corrosion. Therefore, this invention has been developed to overcome the corrosive tendency and to utilize the non-biocidal properties of sodium hypochlorite, while maintaining the biocidal properties of the final composition.

The process of this invention can be performed by (1) first generating sodium hypochlorite in situ by passing an electric current through an aqueous salt water composition and (2) then adding an ammonia-containing component to the aqueous composition containing the sodium hypochlorite. The ammonia-containing component reacts with, and converts, the sodium hypochlorite to monochloramine having biocidal properties.

Alternatively, the process of this invention can be performed by (1) first adding an ammonia-containing component to an aqueous composition containing salt water and (b) then passing an electric current through the aqueous composition to generate in situ sodium hypochlorite. Again, the ammonia-containing component reacts with, and converts, the sodium hypochlorite to monochloramine having biocidal properties.

As significant advantages of either process, (a) the corrosiveness of the biocidal chloramine composition is substantially reduced as compared to the corrosiveness of the composition containing the in situ generated sodium hypochlorite and (b) the biocidal properties provided by monochloramine in the final composition are retained.

The reduced corrosiveness of the final biocidal composition prevents or at least minimizes downtime for cleaning and/or replacement of the equipment or metallic parts affected by corrosion.

The in situ generation of sodium hypochlorite by passing an electric current through an aqueous salt water composition is a known process in the art.

The ammonia-containing component can be selected from a variety of components, but preferred in this invention are aqueous ammonia, ammonium sulfate, ammonium phosphate and ammonium chloride.

The reaction of the ammonia-containing component and the in situ generated sodium hypochlorite must be carefully controlled to achieve a quantitative conversion of sodium hypochlorite to monochloramine (i.e., a reaction yield of at least about 95 percent, preferably at least about 97 percent). Careful control of the reaction is also necessary to avoid production of unwanted byproducts, such as dichloramine and nitrogen trichloride.

The most important controls to maintain in the reaction mixture are (a) an excess of ammonia, or at least no excess hypochlorite; (b) an alkaline pH, preferably at least about 10 to about 11; and (c) a concentration of monochlorine below about 1-2 percent. With these reaction controls, the conversion of sodium hypochlorite to monochloramine will be about 95 percent, preferably about 97 percent.

To confirm the conversion of sodium hypochlorate to monochloramine, there are two available tests—(1) one to determine free chlorine in the reaction mixture and (2) the second to specifically determine the presence of monochloramine. The results of these 2 tests should agree, within experimental error, if the only active chlorine species in the reaction mixture is monochloramine.

The present invention is further illustrated by the following examples which are illustrative of certain embodiments designed to teach those of ordinary skill in the art how to practice this invention and to represent the best mode contemplated for carrying out this invention.

### Example 1

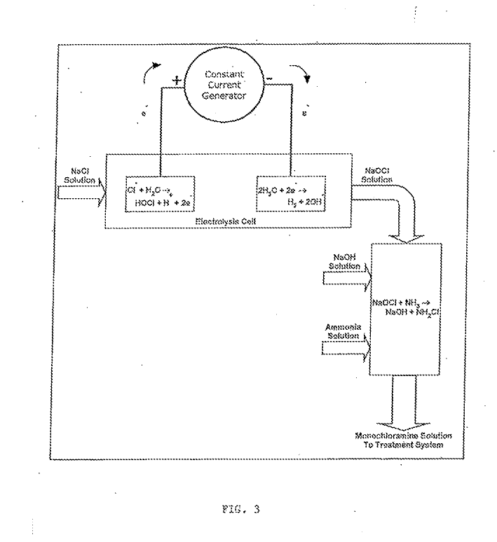

With reference to the flow chart of FIG. 3, an aqueous solution of sodium chloride (NaCl) is passed through an electrolysis cell comprised of at least two electrodes (an anode and a cathode) connected to a power supply. As the solution flows through the cell, the chloride ion (Cl⁻) is oxidized to hypochlorous acid (HOCl) at the anode, and water (H₂O) is reduced to hydrogen gas (H₂) and hydroxide ion (OH⁻) at the cathode; as shown by:

At the Anode: Cl⁻+H₂O→HOCl+H⁺+2e⁻

At the Cathode: 2H₂O+2e⁻→H₂↑+2OH⁻

Overall Reaction: Cl⁻+2H₂O→HOCl+H₂↑+OH⁻

Or: Cl⁻+H₂O→OCl⁻+H₂↑

In these reactions, two moles of electrons (e⁻) are produced as each mole of active chlorine (hypochlorous acid, HOCl, or hypochlorite ion, OCl⁻) is produced. The rate at which active chlorine is produced will be controlled by the electric current (measured in amperes) that passes through the cell. One ampere is defined as one coulomb of charge being transferred through the cell per second, and one mole of electrons will carry 96,485 coulombs of charge (the Faraday constant). Hence at 100% efficiency one ampere will produce 0.0163 gm of HOCl per minute.

Certain factors must be carefully controlled to optimize the conversion of chloride ion to hypochlorous acid and to minimize the formation of unwanted byproducts from the electrolysis reactions; such as:
The rate at which HOCl is produced is limited by the electric current through the electrolysis cell, so an excess of sodium chloride must pass through the cell.
   A current of one ampere can convert up to 0.0182 gm of NaCl per minute, so the product of the concentration of NaCl (in gm NaCl/mL of solution) times the flow rate (in mL/minute) must exceed 0.0182.
   For example, if a 1% solution of NaCl is used, the flow rate through the cell must be >0.55 mL/minute for each ampere of electric current that passes through the cell.
The anode potential must also be monitored to ensure that it is (a) high enough to oxidize the chloride ion but (b) not high enough to initiate other unwanted reactions (such as oxidation of water to form oxygen gas).
To maintain the desired flow of electric current and the correct anode potential, the surface area of the electrodes must be in contact with enough chloride ion to support the desired current without additional reactions (e.g., the oxidation of water to form oxygen gas).
In other words, the electrode area must be large enough to support the necessary current density (amperes/square meter of anode surface area) at the desired anode potential.

The sodium hypochlorite formed by this electrolysis process is then combined with a source of ammonia to form monochloramine. Three criteria must be met to ensure that a quantitative yield of monochloramine is obtained without the formation of unwanted byproducts, such as dichloroamine (NHCl₂) or nitrogen trichloride (NCl₃):
Excess of ammonia (or at least no excess hypochlorite) at all times in the reaction mixture
An alkaline pH in the reaction mixture (preferably from a pH equal to or less than about 10 to a pH equal to or less than about 11)
Final concentration of monochloramine below 1-2% NH₂Cl

The source of ammonia can be provided by many different ammonia-containing components. In this specific example, the ammonia source may be the Busan® 1474 product, which is commercially available from Buckman Laboratories (Memphis, Tenn.) and is a blend of ammonia-containing compounds containing a total of 7.59% ammonia. The sodium hypochlorite from the electrolysis cell is combined with the Busan 1474 product so that a molar ratio of ≥1:1 (NH₃:NaOCl) is maintained. Additional NaOH is added to the solution as needed to maintain the desired pH range.

### Example 2

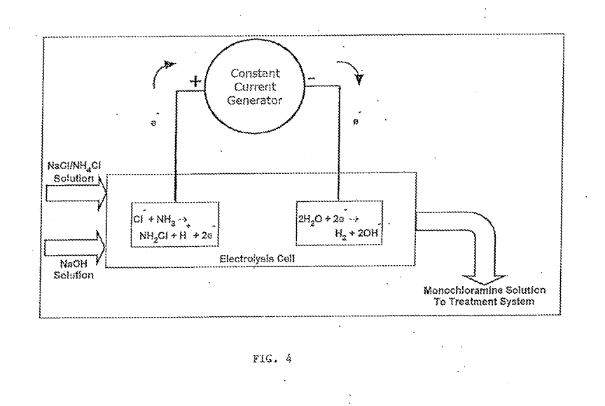

With reference to the flow chart of FIG. 4, an aqueous mixture of sodium chloride and ammonium chloride is passed through an electrolysis cell comprised of at least two electrodes (an anode and a cathode) connected to a power supply. As the solution flows through the cell, the chloride ion

(Cl⁻) is oxidized to hypochlorous acid (HOCl) at the anode, which immediately reacts with the ammonium ion to form monochloramine. Water (H₂O) is simultaneously reduced to hydrogen gas (H₂) and hydroxide ion (OH⁻) at the cathode;

At the Anode: Cl⁻+NH₄⁺+2OH⁻→NH₂Cl+2H₂O+2e⁻

At the Cathode: 2H₂O+2e⁻→H₂↑+2OH⁻

Overall Reaction: Cl⁻+NH₄⁺→NH₂Cl+H₂↑

A small amount of sodium hydroxide solution may be fed to the cell along with the sodium chloride/ammonium chloride solution to ensure that the pH is in the correct range to obtain a good yield of monochloramine.

The factors described in Example 1 that are important for the efficient production of a high quality monochloramine solution are equally important in this example and, therefore, are incorporated into this example. As described above, the concentration of chloride ion in the electrolyte solution and the flow rate through the electrolysis cell must be maintained at a level that will provide an excess of chloride ion (relative to the electric current) in the cell at all times. Careful monitoring and control of the pH and of the anode potential will be even more critical to prevent oxidation of the ammonium ion in the electrolysis cell.

The process of Example 2 is simpler and less complex than the process described in Example 1.

A major advantage in both Examples 1 and 2 over the use of commercially-available bleach is the absence of sodium chlorate (NaClO₃) in the resulting monochloramine solution. Regulatory agencies are beginning to take a closer look at the levels of sodium chlorate in many applications as well as in environmental situations.

Sodium chlorate is formed by a disproportionation reaction that occurs in commercially-available bleach during storage:

3NaOCl→2NaC+NaClO₃

Since the sodium hypochlorite in both Examples 1 and 2 is converted to monochloramine immediately after it is generated, there is no storage time during which sodium chlorate will be generated. Hence there will be little or no sodium chlorate in the monochloramine solution that is fed to the treatment system.

This invention has been described with particular reference to certain embodiments, but variations and modifications can be made without departing from the spirit and scope of the invention.

1. A process for substantially reducing the corrosiveness of a biocidal composition containing in situ generated sodium hypochlorite, wherein the process comprises the following steps of:
A. generating sodium hypochlorite in situ by passing an electric current through a first aqueous salt water composition;
B. adding an ammonium-containing component to the first composition containing in situ generated sodium hypochlorite;
whereby the sodium hypochlorite is substantially converted to a haloamine having biocidal properties and whereby the corrosiveness of the biocidal composition is substantially reduced as compared to the corrosiveness of the first composition containing the in situ generated sodium hypochlorite.

2. A process as defined by claim 1 wherein the haloamine is monochloramine or monobromoamine.

3. A process as defined by claim 2 wherein the bromamine is monochloramine.

4. A process as defined by claim 2 wherein the haloamine is monobromoamine.

5. A process as defined by claim 1 wherein the ammonium-containing component is an ammonium salt or aqueous ammonia.

6. A process as defined by claim 5 wherein the ammonium-containing component is aqueous ammonia.

7. A process as defined by claim 5 wherein the ammonium salt is ammonium sulfate.

8. A process as defined by claim 5 wherein the ammonium salt is ammonium phosphate.

9. A process as defined by claim 5 where the ammonium salt is ammonium chloride.

10. A process as defined by claim 1 wherein the pH is maintained at an alkaline pH.

11. A process as defined by claim 10 wherein the pH is maintained in a range from about 10 to about 11.

12. A process for substantially reducing the corrosiveness of a biocidal composition containing in situ generated sodium hypochlorite, wherein the process comprises the following steps:
A. adding an ammonium-containing component to an aqueous composition containing salt water and
B. passing an electric current through the aqueous composition to generate in situ sodium hypochlorite,
whereby the sodium hypochlorite is substantially converted to a haloamine having biocidal properties and whereby the corrosiveness of the biocidal composition is substantially reduced as compared to the corrosiveness of the composition containing the in situ generated sodium hypochlorite.

13. A process as defined by claim 12 wherein the haloamine is monochloramine or monobromoamine.

14. A process as defined by claim 13 wherein the bromamine is monochloramine.

15. A process as defined by claim 13 wherein the haloamine is monobromoamine.

16. A process as defined by claim 12 wherein the ammonium-containing component is an ammonium salt or aqueous ammonia.

17. A process as defined by claim 16 wherein the ammonium-containing component is aqueous ammonia.

18. A process as defined by claim 16 wherein the ammonium salt is ammonium sulfate.

19. A process as defined by claim 16 wherein the ammonium salt in ammonium phosphate.

20. A process as defined by claim 16 wherein the ammonium salt is ammonium chloride.

21. A process as defined by claim 12 wherein the pH is maintained at an alkaline pH.

22. A process as defined by claim 21 wherein the pH is maintained in a range from about 10 to about 11.
